(19) United States
(12) Patent Application Publication
(10) Pub. No.: US 2009/0299800 A1
(43) Pub. Date: Dec. 3, 2009

(54) Device maintenance scheduling method and system

(75) Inventor: Michael J. Neilan, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/156,147

(22) Filed: May 30, 2008

(51) Int. Cl. G06Q 10/00; G06F 15/16

(52) U.S. Cl. 705/8; 709/202; 705/7

(57) ABSTRACT

Maintenance schedules and costs for a network of self-service terminals are generated based upon usage data for respective peripheral devices at each of the self-service terminals.

### FIELD OF THE INVENTION

The present invention relates to device maintenance scheduling method and system. More particularly, but not exclusively, the invention relates to a self-service terminal device maintenance scheduling method and system.

### BACKGROUND TO THE INVENTION

Common examples of self-service terminals (SSTs) include automated teller machines (ATMs), information kiosks, financial services centres, bill payment kiosks, lottery kiosks, postal services machines, check-in and check-out terminals such as those used in the hotel, car rental, and airline industries, retail self-checkout terminals, vending machines, and the like.

Typically, in networks of managed SSTs, such as automated teller machines (ATMs), a management agent runs on each device in the network. Typically, in the case of internet protocol (IP) based networks the management agents are simple network management protocol agents (SNMP). These SNMP agents collect data relating to the operation of the managed devices.

In the case of a network of ATMs, each ATM runs an agent, for example an SNMP agent that monitors the operation of the peripheral devices of an ATM, for example the number of cash dispense operations, the amount of cash associated with each cash dispense operation and each time a journal printer is operated.

Typically, older ATMs, sometimes referred to a “legacy systems”, monitor downtime using system network architecture (SNA) in which the ATM itself keeps a log of their usage, status and how many operations have taken place in a specified time period, for example “How many receipts have been printed since the thermal paper roll was last changed?”

Thus, the collection of data relating to transaction volumes associated with each of the peripheral devices comprising the ATM is known. However, this data is often lost when the ATM is serviced. Thus removing the possibility of using the data in assessing the maintenance requirements of the ATM network.

Additionally, the assessment and scheduling of ATM maintenance is generally carried out manually, and in some instances on an ad-hoc basis. This leads to less than preferable resource allocation and unnecessary expenditure of travel and maintenance time by customer engineers (CEs).

Similarly, cost estimates of ATM maintenance are generally manually formulated with little or no reference to transaction volume data associated with the peripheral devices of an ATM. Rather, cost estimates are based around the “average” cost of servicing an ATM, as opposed to individual machine by machine cost estimates based upon the usage of each ATM within a network.

It will be appreciated that although the foregoing discussion is based around ATM maintenance it is equally applicable to maintenance of any SST.

### SUMMARY OF THE INVENTION

According to a first aspect of the present invention there is provided a method of device maintenance scheduling comprising the steps of:

i) collecting usage data from at least one peripheral device of at least some of a plurality of self-service terminals (SSTs) locally at said SSTs, the usage data being indicative of the number of transactions executed by the at least one peripheral device;

ii) uploading the usage data from at least some of the plurality of SSTs to a management unit via a network, along with identification data, associated with the usage data, that identifies each of the plurality of SSTs from which the usage data is uploaded;

iii) ranking the usage data according to scheduling rules at the management unit; and

iv) generating a maintenance schedule based upon the ranking of Step (iii) and the identification data associated with each piece of usage data at the management unit.

The method may comprise the step of storing the usage data at a plurality of data storage devices within the SST prior to step (ii). At least some of the plurality of data storage devices may be non-volatile data storage devices. Non-limiting examples of non-volatile data storage devices comprise E²PROM, digital versatile disc (DVD), compact disc-read only memory (CD-ROM) and magnetic disc. The method may comprise associating at least one of the plurality of data storage devices with the peripheral device. The method may comprise writing data to some of the plurality of data storage devices with a different frequency than other of the plurality of data storage devices.

Such scattered storage of data reduces the likelihood of data being erased during maintenance, or otherwise lost, by introducing redundancy of data storage into the SST.

The method may comprise collecting usage data from a plurality of peripheral devices of the SST. The method storing the usage data at a plurality of data storage devices within the SST prior to step (ii). The method may comprise associating at least one of the plurality of data storage devices with respective peripheral devices. The method may comprise writing data to some of the plurality of data storage devices with a different frequency than other of the plurality of data storage devices.

The collection of usage data from a number of peripheral devices introduces richness to the data that increases the parameters usable for ranking the data.

The method may comprise writing data to some of the plurality of data storage devices with a different frequency than other of the plurality of data storage devices. The method may comprise writing data to a magnetic disc more frequently than to an E²PROM. The method may comprise associating at least one E²PROM with at least one peripheral device.

The selection of certain data storage devices for more frequent writing operations than other of the data storage devices prevents high failure rates in those data storage devices not suitable for frequent write operations. This increases the reliability of the data storage. The increased reliability of data storage leads to an increased degree of confidence that the data stored relates to the lifetime of the device.

The method may comprise uploading the usage data from one of the plurality of plurality of data storage devices in Step (ii). The method may comprise uploading the usage data from a magnetic disc data storage device in Step (ii).

The method may comprise selecting usage data associated with only one peripheral device of each of the plurality of SSTs to be subject to the scheduling rules in Step (iii).

Alternatively, the method may comprise selecting usage data associated with more than one peripheral device of each of the plurality of SSTs to be subject to the scheduling rules of Step (iii). The method may comprise weighting the usage data associated with each of the more than one peripheral devices for each of the plurality of SSTs to be subject to the scheduling rules of Step (iii). The method may comprise weighting the usage data associated with at least one of more than one peripheral devices with a null weighting such that the usage data of said peripheral device is ignored when ranking the usage data.

The method may comprise defining at least one peripheral device usage threshold limit as one of the scheduling rules of Step (iii). The method may comprise defining differing peripheral device usage threshold limits for different peripheral devices as scheduling rules of Step (iii). The method may comprise defining different peripheral device usage threshold limits for first and second functionally similar peripheral devices present on differing SSTs.

The method may comprise formatting the identification data to comprise an ID number associated with the SST. Typically the ID number is unique and may be a manufacturer ID number. The method may comprise formatting the identification data to comprise an indicium of the geographical location of the SST.

The method may comprise defining a scheduling rule comprising optimising a route between a number of the plurality of SSTs by cross-referencing the schedule generated in Step (iv) and the indicium of the geographical location of each of the number of the plurality of SSTs comprising the identification data.

The method may comprise outputting the maintenance schedule to a user.

At least some of the SSTs may comprise an automatic teller machine (ATM), a check-in/check-out terminal, a medical record entry terminal.

According to a second aspect of the present invention there is provided a method of estimating the cost of maintenance comprising the steps of:

i) collecting usage data from at least one peripheral device of at least some of a plurality of self-service terminals (SSTs) locally at each of the plurality of SSTs, the usage data indicating a number of transactions executed by the at least one peripheral device;

ii) uploading the usage data, and identification data that identifies the SST, from the SST to a management unit via a network; and

iii) assigning a cost to scheduled maintenance for at least some of the plurality of SSTs based upon the content of their respective usage data.

The method may comprise assigning a cost to each SST, within a respective costing band. The method may comprise varying the cost assigned to each SST within the costing band, dependent upon variations in usage data associated with the SST. The method may comprise varying the cost assigned to each SST between costing bands, dependent upon variations in usage data associated with the SST. The method may comprise dividing the cost of maintenance into labour and parts.

At least some of the plurality of SSTs may comprise an automatic teller machine (ATM), a check-in/check-out terminal, a medical record entry terminal.

According to a third aspect of the present invention there is provided a device maintenance scheduling system comprising a plurality of self-service terminals (SSTs) and a management unit, each of the plurality of SSTs comprising a control processor and a data storage device, at least one peripheral device, and an input-output (IO) port, the management unit comprising a management processor and an IO port, the control processor of each of the plurality of SSTs being arranged to collect usage data from the respective at least one peripheral devices and to store said usage data on the data storage device, the control processor being further arranged to instruct the output of the usage data and identification data that identifies the SST from which the usage data originates to the management unit via respective IO ports over a network, the management unit IO port being arranged to receive the usage data from at least some of the plurality of SSTs and to upload the usage data and identification data to the management processor, the management processor being arranged to rank the usage data according to scheduling rules and being further arranged to generate a maintenance schedule based upon the ranked usage data.

At least some of the plurality of SSTs may comprise at a plurality of data storage devices each arranged to store the usage data. At least some of the plurality of data storage devices may be non-volatile data storage devices. Non-limiting examples of non-volatile data storage devices comprise E²PROM, digital versatile disc (DVD), compact disc-read only memory (CD-ROM) and magnetic disc. At least one of the plurality of data storage devices may be associated with a corresponding peripheral device. The control processor may be arranged to write the usage data to some of the plurality of data storage devices with a different frequency than other of the plurality of data storage devices.

The control processor may be arranged to collect usage data from a plurality of peripheral devices of the SST. The usage data may be stored at a plurality of data storage devices within the SST. At least one of the plurality of data storage devices may be associated with a respective peripheral device. The processor may be arranged to write data to some of the plurality of data storage devices with a different frequency than other of the plurality of data storage devices.

The processor may be arranged to write the usage data to some of the plurality of data storage devices with a different frequency than other of the plurality of data storage devices. The processor may be arranged to write the usage data to a magnetic disc more frequently than to an E²PROM. At least one E²PROM may be associated with a respective peripheral device.

The control processor may be arranged to output the usage data from a magnetic disc data storage device to the management unit.

The management processor may be arranged to select usage data associated with only one peripheral device of each of the plurality of SSTs to be subject to the scheduling rules.

Alternatively, management processor may be arranged to select usage data associated with more than one peripheral device of at least some of the plurality of SSTs to be subject to the scheduling rules. The management processor may be arranged to weight the usage data associated with at least some of the peripheral devices comprising respective SSTs. The management processor may be arranged to weight the usage data associated with at least some of the peripheral devices with a null weighting such that the usage data of said peripheral device is ignored when ranking the usage data.

The management processor may be arranged to define at least one peripheral device usage threshold limit as one of the scheduling rules. The management processor may be arranged to define differing peripheral device usage threshold limits for different peripheral devices as scheduling rules. The management processor may be arranged to define different peripheral device usage threshold limits for first and second functionally similar peripheral devices present on differing SSTs.

The identification data may comprise an ID number associated with the SST. Typically the ID number is unique and may be a manufacturer ID number. The identification data may comprise an indicium of the geographical location of the SST.

The management processor may be arranged to define a scheduling rule comprising optimising a route between a number of the plurality of SSTs by cross-referencing the schedule and the indicium of the geographical location of each of the number of the plurality of SSTs comprising the identification data.

Management processor may be arranged to output the maintenance schedule to a user.

At least some of the plurality of SSTs may comprise an automatic teller machine (ATM), a check-in/check-out terminal, a medical record entry terminal.

According to a fourth aspect of the present invention there is provided software which, when executed on a processor, causes the processor to rank usage data collected from at least one peripheral device of at least some of a plurality of self-service terminals (SSTs), uploaded from at least some of the plurality of SSTs, according to scheduling rules, and to generate a maintenance schedule based upon said ranking and identification data associated with each piece of usage data.

According to a fifth aspect of the present invention there is provided a data carrier bearing software according to the fourth aspect of the present invention.

According to a sixth aspect of the present invention there is provided software which, when executed on a processor, causes the processor to upload the usage data, and identification data from each of a plurality of self-service terminals (SSTs), the usage data being indicative of the number of transactions executed by at least one of a plurality of peripheral devices of the SST, the identification data identifying the SST and further causes the processor to assign a cost to scheduled maintenance for at least some of the plurality of SSTs based upon usage data.

According to a seventh aspect of the present invention there is provided software a data carrier bearing software according to the sixth aspect of the present invention.

According to eighth aspect of the present invention there is provided a management unit comprising a management processor and an IO port, the management unit IO port being arranged to receive usage data indicative of the usage of at least one peripheral device forming part of one of a plurality of self-service terminals (SSTs) from at least some of the plurality of SSTs and to upload the usage data and identification data that identifies a respective one of the plurality of SSTs to the management processor, the management processor being arranged to rank the usage data according to scheduling rules and being further arranged to generate a maintenance schedule based upon the ranked usage data and identification data.

According to an ninth aspect of the present invention there is provided a self-service terminal (SST) forming part of a network of SSTs comprising a control processor and a data storage device, at least one peripheral device, and an input-output (IO) port, the control processor of the SST being arranged to collect usage data from the at least one peripheral devices and to store said usage data on the data storage device, the control processor being further arranged to instruct the output of the usage data and identification data that identifies the SST originates to a management unit via the IO port.

The SST may comprise an automatic teller machine (ATM), a check-in/check-out terminal, a medical record entry terminal.

### BRIEF DESCRIPTION OF THE DRAWINGS

Embodiments of the present invention will now be described, by way of example only, with reference to the accompanying drawings, in which:

FIG. 1 is a schematic diagram of an embodiment of a device maintenance scheduling system according to an aspect of the present invention; and

FIG. 2 is schematic diagram of selected internal components of an ATM forming part of the system of FIG. 1;

FIG. 3 is flow chart showing the steps of a device maintenance scheduling method according to another aspect of the present invention; and

FIG. 4 is a flow chart showing the steps of a method of estimating the cost of maintenance according to a further aspect of the present invention.

### DETAILED DESCRIPTION

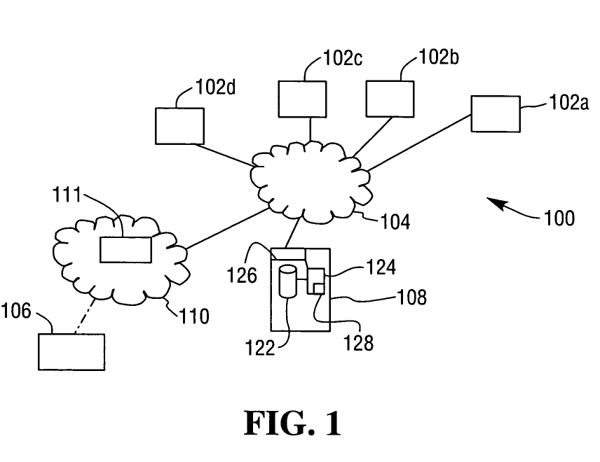

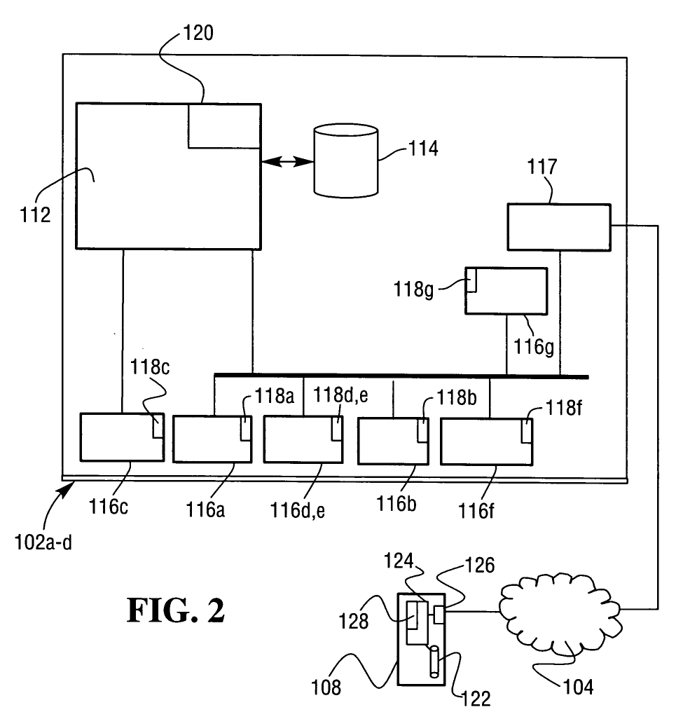

Referring now to FIGS. 1 and 2, a managed network of SSTs 100 comprises, for example, ATMs 102a-d, a communications network 104, an authorisation host 106, a management unit 108 and an interchange network 110.

Each ATM 102a-d comprises a control processor 112, a data storage device 114, a number of peripheral devices 116a-g, and a network connection 117. Typically, the control processor 112 is a PC core operating under a Microsoft Windows™ operating system. Normally, the data storage device 114 is a magnetic disc.

Typical peripheral devices found in the ATMs 102a-d include, but are not limited to, a card reader device 116a, a receipt printer device 116b, a display 116c and associated function display keys (FDKs) 116d, an encrypting keypad device 116e, a dispenser device 116f, and a journal printer device 116g for creating a record of transactions executed by the respective ATM 102a-d. Typically, each of the peripheral devices 116a-g has a non-volatile memory element 118a-g associated with it, for example in the form of an E²PROM. Although described with each peripheral device 116a-g having a respective non-volatile memory element 118a-g associated with it, it will be appreciated that only some of the peripheral devices 116a-g may have a non-volatile memory element associated with them.

The communications network 104 comprises a secure network over which transactions data for transactions executed at the ATMs 102a-d passes to the authorisation host 106. Typically, the communications network 104 is a private network or a VPN.

The authorisation host 106 authorises “on us” transactions (that is, where the financial institution operating the ATM network 100 is also the issuer of a card used by the customer). “Not on us” transactions are routed to authorisation hosts of other financial institutions via the interchange network 110.

The management unit 108 comprises a data storage device 122, a management processor 124 and a network connection 126. The management processor 124 runs scheduling software 128.

The interchange network 110 comprises a switch 111 to which all ATMs 102a-d in the network 100 are connected. The switch 111 determines where a request from any given ATM 102a-d is routed dependent upon, for example, which financial institution that a user making a request is a customer of, i.e. is the transaction “on-us” or “not on-us”. It is possible that the switch 111 could operate a processor as a management processor 124.

Each ATM 102a-d runs a management routine 120 upon their respective processors 112. The management routine 120 logs, inter alia, each instance of use of the peripheral devices 116a-g in the form of usage data. Typically, the usage data may be contain an indication of the number of peripheral devices of a given type that have been installed in an ATM 102a-d during its operational lifetime, the number of operations that the current peripheral device has carried out and the total number of operations carried out by all peripheral devices of a particular type. For example, there may have been four receipt printers 116b in a particular ATM 102a with the current receipt printer 116b having printed ten thousand receipts and the total number of receipts printed over the operational lifetime of the ATM 102a being ninety thousand. Accordingly, in the preceding example, the usage data would have a format of “4 10,000 90,000”. It will be appreciated that the order of the information contained within the usage data can be varied according to the requirements of the system. It will be further appreciated that any one, or combination of the usage data parameters described in the preceding example may be omitted if required, or additional usage data parameters introduced as required.

The management routine 120 transfers the usage data to the data storage device 114 and to each of the non-volatile memory elements 118a-g. Typically, the management routine 120 transfers the usage data to the data storage device 114 either in real time or very frequently, for example every five minutes. By contrast aggregate usage data is transferred to the non-volatile memory elements 118a-g less frequently, for example once every twenty four hours.

The management processor 124 interrogates each ATM 102a-d over the communications network 104, via the network connections 117, 124, for the usage data. Typically, the management processor 124 interrogates the ATMs 102a-d every hour. It may be that the management processor 124 requests the usage data relating only selected peripheral devices 116a-g, for example the card reader 116a as this is used to initiate most transactions on an ATM and will therefore give a reasonable indication of the usage of each of the ATMs 102a-d. Alternatively, the management processor 124 may request the usage data of all of the selected peripheral devices 116a-g.

The control processor 104 of each ATM 102a-d accesses the respective data storage device 114, and reads the usage data for the ATM's peripheral devices 116a-g that the management processor 124 has requested. The usage data from each of the peripheral devices 116a-g is transferred across the communications network 104 to the management unit 108 where it is stored on the data storage device 122. Should the data storage device 114 not be accessible usage data can be obtained from the non-volatile memory elements 117a-g, although this usage data will not be as up-to-date as that stored on the data storage device 114.

The management processor 124 accesses the usage data stored on the data storage device 122 and uses the scheduling software 128 in order to determine a ranking of each of the ATMs in terms of their usage according to scheduling rules. An example of a scheduling rule includes a transaction volume threshold, for example a card reader usage count of two hundred thousand operations could be a threshold for a routine service of a particular ATM. A further example is a threshold based upon the number of bills that the dispenser device 116f has dispensed. This differs from country to country as the number of bills required to fulfil a user's request will vary and so the threshold may be set by multiplying the number of cash dispense operations carried out by the dispenser device 116f by the average number of bills dispensed in the country that the ATM of interest is based in. These thresholds can, if required, be defined independently for each ATM 102a-d as the network 100 may comprise ATMs manufactured by various manufacturers and each may have different servicing requirements. Alternatively, the thresholds could be set uniformly across all of the ATMs 102a-d in the network 100.

It is envisaged that the management unit 108 may be operated by an outsourced service provider and under these circumstances the usage threshold can, if required, be defined independently for a number of distinct networks belonging to different financial institutions supported by the service provider. Furthermore, each ATM within one of the distinct networks may have thresholds set independently, if required, as described hereinbefore.

Further, if usage data from some or all of the peripheral devices 116a-g is transferred from the ATMs 102a-d to the scheduling software 128 can be configured to weight usage data from each peripheral device 116a-g. This allows complex scheduling rules to be developed. For example, if a receipt printer shows that it has been used one thousand times can be null weighted, provided that the dispense unit 116f has dispensed less than fifty thousand notes, as if the receipt printer is out of service this is an comparatively minor inconvenience to a user rather than the inability of the ATM to dispense cash.

If a determination that an ATM 102a-d requires maintenance a cost estimate is generated by cross-referencing the scheduling rule that has been contravened with an entry in a costing database 130 stored on the data storage 122 device of the management unit 108. Typically, the entries in the costing database 130 will relate to costing bands with each ATM 102a-d being placed in a costing band dependent upon its usage. For example, a city centre ATM 102a with a usage of five thousand transactions per day may be placed in a high costing band, whereas an ATM 102d located in a rural village may have a usage of only one hundred transactions per day. As noted above a measure of overall usage of an ATM can be estimated from, for example, the usage data relating to the card reader device 116a. Within each costing band there are sub-divisions, for example an ATM 102b having two thousand transactions per day may lie in the same costing band as one having five thousand transactions per day but at a lower price point within the band. ATMs 102a-d can move within costing bands an also between costing bands dependent upon their usage. If an ATM 102a-d moves either within, or between, costing bands the costing database 130 is updated accordingly.

In one embodiment, the usage data may be averaged over a period, for example one week to prevent an ATM moving between costing bands too frequently, for example an ATM 102c close to a sports stadium may experience usage high enough to move it up a costing band at the time of a sporting event at the stadium. However, such a sporting event may occur only once a month and the maintenance needs of the ATM would be based around the average usage or trend data over a defined period, for example one week or one month.

In an embodiment, the costing database 130 is a look up table in which entries corresponding to particular maintenance events are referenced to monetary costs for parts and labour separately. For example the replacement of a receipt printer may cost $50 parts and $200 labour. These costs can be separated out or presented as a composite costing for the maintenance work if necessary. Such a division of the cost into parts and labour allows for a flexible response to variations in the cost of parts or labour rates and yields transparency to customers.

In an embodiment, the management processor 120 can also determine if a systemic problem exists within an ATM 102a-d. The scheduling software 128 may contain a monitoring sub-routine that compares actual peripheral device failure rates with expected failure rates by means of replacement thresholds. Typically, a replacement threshold will comprise the expected number of operations after which a particular peripheral device will require replacement with an added tolerance, for example 25% of the expected number of operations. For example, a card reader device 116a may be expected to operate for two hundred thousand operations. However, where the usage data for a card reader device 116a in a particular ATM 102c indicates that the card reader device 116a has been replaced, for example, five times for thirty thousand operations, for example “5 6,000 30,000”, the scheduling software 128 will flag this as being indicative of a systemic problem with that ATM 102c. This flag allows the dispatch of a customer engineer to examine the machine in detail. It may also be the case that if the systemic problem is related to, for example, vandalism, or another suitable external factor, the ATM in question may move to a higher point in its existing costing band or move to a higher costing band. Conversely, if the systemic problem had pushed the ATM in question to a higher costing point its resolution may allow the ATM in question to move down within its costing band, or to a lower costing band. If the ATM in question moves either within, or between, costing bands the costing database 130 is updated accordingly.

In one embodiment, the scheduling software 128 is arranged to flag peripheral devices that have been operating beyond their expected usage lifetime for replacement. For example, the receipt printer 116f may be designed to print, for example, two hundred thousand receipts and if the usage data of the receipt printer 116f of a particular ATM 102a shows that it has printed, for example four hundred thousand receipts, the scheduling software 128 may flag the receipt printer 116f as requiring replacement at the next routine maintenance call to the ATM 102a. This is because it is sometimes more efficient to replace a peripheral device whilst carrying out a routine maintenance, or service, call rather than have multiple call outs to an ATM.

It will be appreciated that although described with reference to a discrete management unit 108, in another embodiment the authorisation host 106 may function as the management unit with the scheduling software 128 running upon a processor of the authorisation host 106 and a SST maintenance supplier accesses the scheduling data upon the authorisation host 106 remotely.

It will be further appreciated that although described with reference to a discrete management unit 108, in yet another embodiment the switch 111 of the interchange network 110 can run the scheduling software 128 as a switch application and a SST maintenance supplier can access the scheduling data upon the switch 111 remotely.

It will be still further appreciated that although described with reference to a discrete management unit 108, in a still further embodiment one of the SSTs 102a-d can operate as the management unit. In this embodiment the SST 102a-d receives usage data from the other SSTs and run the scheduling software 128 to produce a maintenance schedule. This maintenance schedule is then either uploaded to a maintenance provider's server or is accessed remotely by the maintenance provider.

It will be further appreciated that although described with reference to ATMs comprising the same peripheral devices the present invention is applicable to ATMs having some, or no, common peripheral devices.

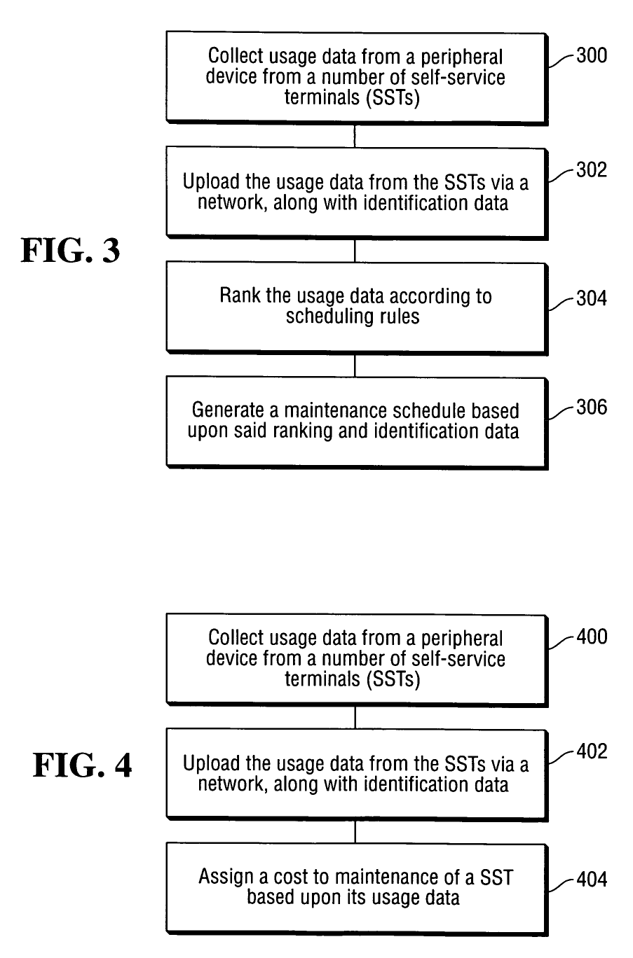

Referring now to FIG. 3, a method of device maintenance scheduling comprises collecting usage data from a peripheral device from a number of self-service terminals (SSTs) (Step 300). Typically, the usage data is collected and stored locally at the SSTs. The usage data indicates the number of transactions executed by the one peripheral device. A management unit uploads the usage data from the SSTs via a network, along with identification data (Step 302). The identification data identifies each of the SSTs from which the usage data is uploaded and is correlated to the usage data. The management unit ranks the usage data according to scheduling rules (Step 304). The management unit then generates a maintenance schedule based upon said ranking and the identification data (Step 306).

Referring now to FIG. 4, a method of estimating the cost of maintenance comprises collecting usage data from a peripheral device of a number of self-service terminals (SSTs). (Step 400). Typically, the usage data is collected and stored locally at the SSTs. The usage data indicates the number of transactions executed by the one peripheral device. A management unit uploads the usage data from the SSTs via a network, along with identification data (Step 402). The identification data identifies each of the SSTs from which the usage data is uploaded and is correlated to the usage data. A cost is assigned to scheduled maintenance for some of the SSTs based upon the content of the usage data (Step 404).

It will be appreciated that non-mutually exclusive features or embodiments as described hereinbefore may be freely interchanged and incorporated within the scope of the invention.

It will be appreciated that although described with reference to a distributed network of ATMs the present invention can be any suitable managed network of self-service terminals, for example medical record entry terminals or self-check in/out terminals.

Various modifications may be made to the above described embodiment within the scope of the invention without departing from the spirit of the invention.

1. A method of device maintenance scheduling comprising the steps of:
i) collecting usage data from at least one peripheral device of at least some of a plurality of self-service terminals (SSTs) locally at said SSTs, the usage data being indicative of the number of transactions executed by the at least one peripheral device;
ii) uploading the usage data from at least some of of the plurality of SSTs to a management unit via a network, along with identification data, associated with the usage data, that identifies each of the plurality of SSTs from which the usage data is uploaded;
iii) ranking the usage data according to scheduling rules at the management unit; and
iv) generating a maintenance schedule based upon the ranking of Step (iii) and the identification data associated with each piece of usage data at the management unit.

2. The method of claim 1, comprising selecting usage data associated with only one peripheral device of at least some of the plurality of SSTs to be subject to the scheduling rules in Step (iii).

3. The method of claim 1, comprising selecting usage data associated with more than one peripheral device of at least some of the plurality of SSTs to be subject to the scheduling rules of Step (iii).

4. The method of claim 3, comprising weighting the usage data associated with each of the more than one peripheral devices for at least some of the plurality of SSTs.

5. The method of claim 1, comprising defining at least one peripheral device usage threshold limit as one of the scheduling rules of Step (iii).

6. The method of claim 1, comprising defining differing peripheral device usage threshold limits for different peripheral devices as scheduling rules of Step (iii).

7. The method of claim 1, comprising defining different peripheral device usage threshold limits for first and second functionally similar peripheral devices present on differing SSTs.

8. The method of claim 1, formatting the identification data to comprise an ID number associated with the SST.

9. The method of claim 8, comprising defining a scheduling rule comprising optimising a route between a number of the plurality of SSTs by cross-referencing the schedule generated in Step (iv) and an indicium of the geographical location of each of the number of the plurality of SSTs comprising the identification data.

10. The method of claim 1, comprising assigning a cost to the maintenance based upon which of the scheduling rules has been violated.

11. The method of claim 1, wherein at least some of the SSTs comprise: an automatic teller machine (ATM), a check-in/check-out terminal, a medical record entry terminal.

12. A device maintenance scheduling system comprising a plurality of self-service terminals (SSTs) and a management unit, each of the plurality of SSTs comprising a control processor and a data storage device, at least one peripheral device, and an input-output (IO) port, the management unit comprising a management processor and an IO port, the control processor of each of the plurality of SSTs being arranged to collect usage data from the respective at least one peripheral devices and to store said usage data on the data storage device, the control processor being further arranged to instruct the output of the usage data and identification data that identifies the SST from which the usage data originates to the management unit via respective IO ports over a network, the management unit IO port being arranged to receive the usage data from at least some of the plurality of SSTs and to upload the usage data and identification data to the management processor, the management processor being arranged to rank the usage data according to scheduling rules and being further arranged to generate a maintenance schedule based upon the ranked usage data and the corresponding identification data.

13. The system of claim 12, wherein the management processor is arranged to select usage data associated with only one peripheral device of each of the plurality of SSTs to be subject to the scheduling rules.

14. The system of claim 12, wherein the management processor may be arranged to select usage data associated with more than one peripheral device of at least some of the plurality of SSTs to be subject to the scheduling rules.

15. The system of claim 12, wherein the management processor is arranged to weight the usage data associated with at least some of the peripheral devices comprising respective SSTs.

16. The system of claim 12, wherein the management processor is arranged to define at least one peripheral device usage threshold limit as one of the scheduling rules.

17. The system of claim 12, wherein the identification data comprises an ID number associated with the SST.

18. The system of claim 12, wherein at least some of the plurality of SSTs comprise: an automatic teller machine (ATM), a check-in/check-out terminal, a medical record entry terminal.

19. A management unit comprising a management processor and an IO port, the management unit IO port being arranged to receive usage data indicative of the usage of at least one peripheral device forming part of one of a plurality of self-service terminals (SSTs) from at least some of the plurality of SSTs and to upload the usage data, and identification data that identifies a respective one of the plurality of SSTs, to the management processor, the management processor being arranged to rank the usage data according to scheduling rules, and being further arranged to generate a maintenance schedule based upon the ranked usage data and identification data.

20. A method of estimating the cost of maintenance comprising the steps of:
i) collecting usage data from at least one peripheral device of at least some of a plurality of self-service terminals (SSTs) locally at each of the plurality of SSTs, the usage data indicating a number of transactions executed by the at least one peripheral device;
ii) uploading the usage data, and identification data that identifies the SST, from the SST to a management unit via a network; and
iii) assigning a cost to scheduled maintenance for at least some of the plurality of SSTs based upon the content of their respective usage data.
